(19) United States
(12) Patent Application Publication
(10) Pub. No.: US 2023/0104264 A1
(43) Pub. Date: Apr. 6, 2023

(54) VEHICLE COMPONENT

(71) Applicant: TOYODA GOSEI CO., LTD., Kiyosu-shi (JP)

(72) Inventor: Shinichi DOKE, Kiyosu-shi (JP)

(21) Appl. No.: 17/956,949

(22) Filed: Sep. 30, 2022

(30) Foreign Application Priority Data
Oct. 5, 2021 (JP) 2021-164208

(51) Int. Cl. G01S 7/02

(52) U.S. Cl. CPC G01S 7/027

(57) ABSTRACT

A vehicle component includes an electromagnetic wave reflection portion that reflects an electromagnetic wave. The vehicle component is made of a dielectric. Thickness L₂ of the electromagnetic wave reflection portion is set based on the following equation:

$${L}_{2} = ( 2 n + 1 ) \frac{λ g}{4}$$

where n is an integer greater than or equal to 0 and λg is a wavelength of the electromagnetic wave in the dielectric.

### BACKGROUND

### 1. Field

The present disclosure relates to a vehicle component.

### 2. Description of Related Art

### BACKGROUND

Generally, vehicles are equipped with a radar device (e.g., a millimeter wave radar device) that transmits electromagnetic waves (e.g., millimeter waves) toward the outside of the vehicle. The electromagnetic waves transmitted from the radar device strike and are reflected by an object outside the vehicle including, for example, a vehicle leading the above vehicle and pedestrians. Then, the electromagnetic waves are received by the radar device. Using the transmitted and received electromagnetic waves, the radar device recognizes the object and detects, for example, the distance between the vehicle and the object.

When seen from the outside of the vehicle, the radar device has a reduced aesthetic appeal. Thus, the radar device needs to be difficult to see from the outside of the vehicle. However, when the radar device is arranged on the inner side of an existing exterior component (e.g., a bumper) for the vehicle, the exterior component interferes with the electromagnetic waves produced by the radar device. To solve this problem, the exterior part may include an electromagnetic wave passing member (see, for example, Japanese Patent No. 6304777).

Since the exterior part includes the electromagnetic wave passing member, the exterior part permits passage of the electromagnetic waves transmitted from the radar device incorporated in a different vehicle. Accordingly, the above vehicle is not easily detected by the radar device incorporated in the different vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A vehicle component that achieves the above vehicle component includes an electromagnetic wave reflection portion that reflects an electromagnetic wave. The vehicle component is made of a dielectric. Thickness L₂ of the electromagnetic wave reflection portion is set based on the following equation 1:

$${L}_{2} = ( 2 n + 1 ) \frac{λ g}{4} \qquad ( equation 1 )$$

where n is an integer greater than or equal to 0 and λg is a wavelength of the electromagnetic wave in the dielectric.

Other features and aspects will be apparent from the following detailed description, the drawings, and the claims.

### BRIEF DESCRIPTION OF DRAWINGS

FIG. 1 is a diagram of a vehicle component according to an embodiment applied to a front grille for a vehicle, schematically showing the front grille together with a millimeter wave radar device incorporated in the vehicle.

FIG. 2 is a diagram illustrating the relationship between a unit circle and the waveform of a millimeter wave in the embodiment.

FIG. 3 is a waveform graph illustrating the phase difference between reflected waves in the embodiment.

FIG. 4 is a diagram schematically showing an operation produced when the reflected waves cancel each other out in the millimeter wave passage portion of the front grille in the embodiment.

FIG. 5 is a diagram schematically showing an operation produced when the reflected waves intensify each other in the millimeter wave reflection portion of the front grille in the embodiment.

FIG. 6 is a graph showing the relationship between the thickness of the front grille and the reflection amount of a millimeter wave in the embodiment.

FIG. 7 is a diagram schematically showing an operation produced when the reflected waves cancel each other out when the front grille has a double-layer structure in the embodiment.

FIG. 8 is a diagram schematically showing the front grille according to a modification, together with the millimeter wave radar device incorporated in the vehicle.

FIG. 9 is a diagram schematically showing a vehicle rear bumper used as the vehicle component according to another modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A vehicle component according to an embodiment applied to a front grille 12 for a vehicle 11 will now be described with reference to the drawings. In the following description, the direction in which the vehicle 11 travels forward will be referred to as the front, and the reverse direction will be referred to as the rear. The up-down direction refers to the up-down direction of the vehicle 11.

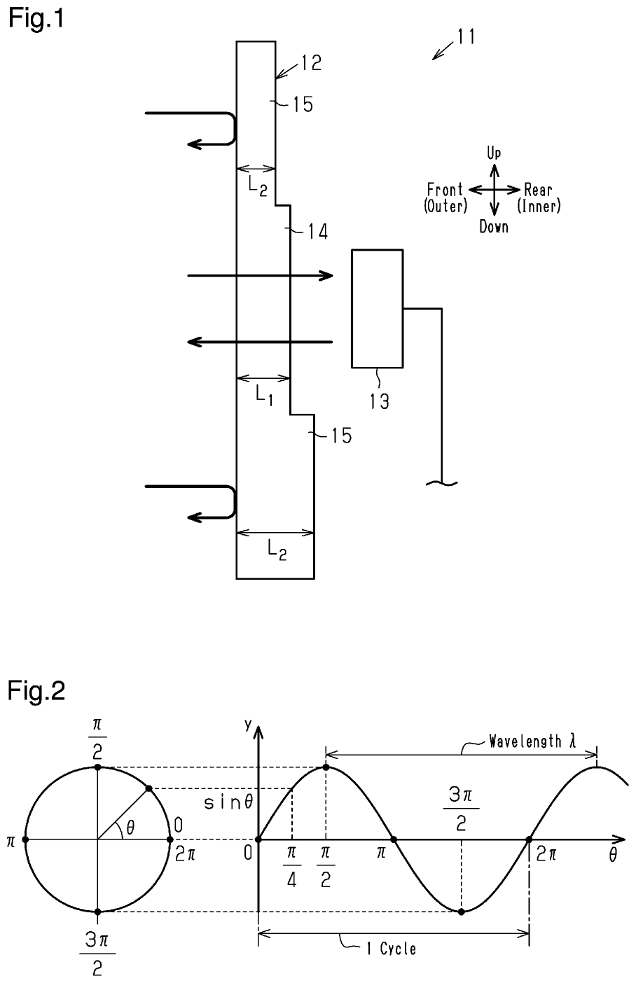

As shown in FIG. 1, a plate-shaped front grille 12 (an example of the vehicle component) is located at the front part of the vehicle 11, with the front grille 12 coupled to the vehicle body. A front-monitoring millimeter wave radar device 13 (an example of the radar device) is located behind the front grille 12 of the vehicle 11. The millimeter wave radar device 13 functions to transmit millimeter waves (electromagnetic waves) frontward at the outside of the vehicle 11 and receive the millimeter waves that have struck and have been reflected by an object outside the vehicle 11.

More specifically, the front grille 12 is located in a path of millimeter waves for the millimeter wave radar device 13. Millimeter waves are radio waves each having a wavelength of 1 mm to 10 mm and a frequency of 30 GHz to 300 GHz.

In the description of the front grille 12, the side of the ornamental surface (the left side in FIG. 1) of the front grille 12 is referred to as the outer side, and the side opposite the ornamental surface (the right side in FIG. 1) is referred to as the inner side. The front grille 12 is arranged upright such that its outer surface (ornamental surface) is oriented toward the front of the vehicle 11 and its inner surface is oriented toward the rear of the vehicle 11. In the arrangement of the front grille 12, the outer side of the emblem 12 corresponds to the outer side of the vehicle 11, and the inner side of the emblem 12 corresponds to the rear side of the vehicle 11.

The front grille 12 is made of material having a known relative permittivity, such as a dielectric (e.g., synthetic resin material). The front grill 12 is plate-shaped. The synthetic plastic material used to form the front grille 12 may be transparent or opaque. To facilitate understanding, the front grille 12 includes a single type of dielectric in this example. Instead, the front grille 12 may include multiple types of laminated dielectrics each having a different relative permittivity.

The front grille 12 is located such that the front-rear direction, in which the path of millimeter waves for the millimeter wave radar device 13 extends, corresponds to the thickness direction. The front grille 12 includes a millimeter wave passage portion 14 (an example of an electromagnetic wave passage portion) and a millimeter wave reflection portion 15 (an example of an electromagnetic wave reflection portion). The millimeter wave passage portion 14 has thickness L₁ that allows for the passage of millimeter waves (electromagnetic waves) to the greatest extent. The millimeter wave reflection portion 15 has thickness L₂ that allows for the reflection of millimeter waves (electromagnetic waves) to the greatest extent.

The millimeter wave passage portion 14 is located at a position facing the millimeter wave radar device 13 in the front-rear direction. The parts of the front grille 12 other than the millimeter wave passage portion 14 are all included in the millimeter wave reflection portion 15. The millimeter wave passage portion 14 and the millimeter wave reflection portion 15 are integrally formed through, for example, injection-molding. That is, the front grille 12 includes a one-piece component that includes the millimeter wave passage portion 14 and the millimeter wave reflection portion 15.

Thickness L₁ of the millimeter wave passage portion 14 is set based on the following equation 2. Thickness L₂ of the millimeter wave reflection portion 15 is set based on the following equation 1. In the following equations 1 and 2, n represents an integer greater than or equal to 0, and λg represents the wavelength of each millimeter wave in the dielectric.

$$L i = n \frac{λ g}{2} \qquad ( equation 2 )$$

$${L}_{2} = ( 2 n + 1 ) \frac{λ g}{4} \qquad ( equation 1 )$$

The calculation of thickness L₁ of the millimeter wave passage portion 14, which allows for the passage of millimeter waves to the greatest extent, will now be described.

The above equation 2 is obtained as follows. First, an F-matrix representing the dielectric of the front grille 12 is represented by the following equation 3. In the following equation 3, β represents a propagation constant, L represents the thickness of the dielectric, B represents a normalized susceptance (imaginary part), Z₀ represents a characteristic impedance in a vacuum, j represents an imaginary unit, and εᵣ represents the relative permittivity of the dielectric.

$$\begin{matrix}F = [ \begin{matrix}1 & 0 \\ j \frac{B}{{Z}_{0}} & 1\end{matrix} ] [ \begin{matrix}cos β L & jZ sin β L \\ j \frac{sin β L}{Z} & cos β L\end{matrix} ] \\ = [ \begin{matrix}cos β L & j \frac{{Z}_{0}}{\sqrt{{ε}_{r}}} sin β L \\ j \frac{B cos β L + \sqrt{{ε}_{r}} sin β L}{{Z}_{0}} & - \frac{B sin β L}{\sqrt{{ε}_{r}}} + cos β L\end{matrix} ] \\ = [ \begin{matrix}A & E \\ C & D\end{matrix} ]\end{matrix} \qquad ( equation 3 )$$

From the F matrices of the above equation 3, a reflection coefficient R is calculated using the following equation 4. The reflection coefficient R represents the degree of reflection occurring in an interface (the ratio of reflected wave to incident wave). The reflection coefficient R is 0 when no reflection occurs (when waves completely pass through).

$$R = \frac{A + \frac{E}{{Z}_{0}} - {Z}_{0} C - D}{A + \frac{E}{{Z}_{0}} + {Z}_{0} C + D} \qquad ( equation 4 )$$

All of the millimeter waves pass (completely pass) through the front grille 12 on condition that the reflection coefficient R is 0. Thus, the value of the numerator in the above equation 4 simply needs to be 0. Accordingly, by substituting the values of the F matrices of the above equation 3 into the expression of the numerator in equation 4 and organizing these values, the following equation 5 is obtained.

$$\begin{matrix}A + \frac{E}{{Z}_{0}} - {Z}_{0} C - D = cos β L + j \frac{sin β L}{\sqrt{{ε}_{r}}} - j ( B cos β L + \sqrt{{ε}_{r}} sin β L ) + \\ \frac{B sin β L}{\sqrt{{ε}_{r}}} - cos β L \\ = \frac{B sin β L}{\sqrt{{ε}_{r}}} - \frac{j}{\sqrt{{ε}_{r}}} ( {ε}_{r} - 1 ) sin β L - jB cos β L\end{matrix} \qquad ( equation 5 )$$

The above equation 5 indicates that for the numerator to become 0,B and βL , both need to become 0. The relative permittivity of air is 1. Thus, in a case where millimeter waves enter the front grille 12 from the air, the following equation 6 is obtained by substituting 1 into εᵣ in equation 5 and organizing the values.

$$\begin{matrix}\frac{B sin β L}{\sqrt{1}} - \frac{j}{\sqrt{1}} ( 1 - 1 ) sin β L - jB cos β L = B s in β L - jB cos β L \\ = B ( - j cos β L + sin β L ) \\ = 0\end{matrix} \qquad ( equation 6 )$$

Thus, B is equal to 0 in the above equation 6. When B is equal to 0, sinβL is equal to 0. Thus, the following equation 7 is obtained.

βL=nπ (equation 7)

The relationship between wavelength λg and the propagation constant β is expressed in the following equation 8.

$$β = \frac{2 π}{λ g} \qquad ( equation 8 )$$

By substituting the above equation 8 into the above equation 7 and organizing the values, the following equation 9 is obtained.

$$L = n \frac{λ g}{2} = n \frac{λ}{2 \sqrt{{ε}_{r}}} \qquad ( equation 9 )$$

By applying thickness L₁ of the millimeter wave passage portion 14 to L of the above equation 9, the above equation 2 is obtained. In the above equation 9, λ represents the wavelength of each millimeter wave in the air. In the above equation 9, λg is equal to λ/√εᵣ.

The calculation of thickness L₂ of the millimeter wave reflection portion 15, which allows for the reflection of millimeter waves to the greatest extent, will now be described.

The above equation 1 is obtained as follows. First, an F-matrix representing the dielectric of the front grille 12 is represented by the above equation 3. From the F matrices, the reflection coefficient R is calculated using the above equation 4. By substituting the values of the F matrices of the above equation 3 into the above equation 4 and organizing these values, the following equation 10 is obtained.

$$\begin{matrix}R = \frac{cos β L + j \frac{sin β L}{\sqrt{{ε}_{r}}} - j ( B cos β L + \sqrt{{ε}_{r}} sin β L ) + \frac{B sin β L}{\sqrt{{ε}_{r}}} - cos β L}{cos β L + j \frac{sin β L}{\sqrt{{ε}_{r}}} + j ( B cos β L + \sqrt{{ε}_{r}} sin β L ) - \frac{B sin β L}{\sqrt{{ε}_{r}}} + cos β L} \\ = \frac{\frac{B sin β L}{\sqrt{{ε}_{r}}} + j ( \frac{sin β L}{\sqrt{{ε}_{r}}} - B cos β L - \sqrt{{ε}_{r}} sin β L )}{2 cos β L - \frac{B sin β L}{\sqrt{{ε}_{r}}} + j ( \frac{sin β L}{\sqrt{{ε}_{r}}} + B cos β L + \sqrt{{ε}_{r}} sin β L )}\end{matrix} \qquad ( equation 10 )$$

Since the reflection rate of millimeter waves is a power reflection rate, the following equation 11 is obtained by squaring the above equation 10.

$${\vert R \vert}^{2} = \frac{\frac{{B}^{2} {sin}^{2} β L}{{ε}_{r}} + {( \frac{sin β L}{\sqrt{{ε}_{r}}} - B cos β L - \sqrt{{ε}_{r}} sin β L )}^{2}}{{( 2 cos β L - \frac{B sin β L}{\sqrt{{ε}_{r}}} )}^{2} + {( \frac{sin β L}{\sqrt{{ε}_{r}}} + B cos β L + \sqrt{{ε}_{r}} sin β L )}^{2}} \qquad ( equation 11 )$$

The above equation 11 indicates that when cosβL is equal to 0 and sinβL is equal to ±1, thickness L of the dielectric in which the reflection coefficient R is the maximum is obtained.

$$β L = \frac{( 2 n + 1 )}{2} π ( n is an integer greater than or equal to 0 ) \qquad ( equation 12 )$$

When the above equation 12 is satisfied, cosβL is equal to 0 and sinβL is equal to ±1. Thus, by substituting the above equation 8 into the above equation 12 and organizing the values, the following equation 13 is obtained.

$$L = ( 2 n + 1 ) \frac{λ g}{4} = \frac{( 2 n + 1 )}{4} \times \frac{λ}{\sqrt{{ε}_{r}}} \qquad ( equation 13 )$$

By applying thickness L₂ of the millimeter wave reflection portion 15 to L of the above equation 13, the above equation 1 is obtained. In the above equation 13, λ represents the wavelength of each millimeter wave in the air. In the above equation 13, λg is equal to λ/√εᵣ.

The calculation of the maximum reflection amount [dB] of a dielectric having the relative permittivity εr will now be described.

By substituting 0 into cosβL and 1 into sinβL in the above equation 10 and organizing the values, the following equation 14 is obtained.

$$R = \frac{\frac{B}{\sqrt{{ε}_{r}}} + j ( \frac{1}{\sqrt{{ε}_{r}}} - \sqrt{{ε}_{r}} )}{- \frac{B}{\sqrt{{ε}_{r}}} + j ( \frac{1}{\sqrt{{ε}_{r}}} + \sqrt{{ε}_{r}} )} = \frac{B - j ( {ε}_{r} - 1 )}{- B + j ( {ε}_{r} + 1 )} \qquad ( equation 14 )$$

By substituting 0 into cosβL and −1 into sinβL in the above equation 10 and organizing the values, the following equation 15 is obtained.

$$R = \frac{- \frac{B}{\sqrt{{ε}_{r}}} - j ( \frac{1}{\sqrt{{ε}_{r}}} - \sqrt{{ε}_{r}} )}{\frac{B}{\sqrt{{ε}_{r}}} - j ( \frac{1}{\sqrt{{ε}_{r}}} + \sqrt{{ε}_{r}} )} = \frac{- B + j ( {ε}_{r} - 1 )}{B - j ( {ε}_{r} + 1 )} \qquad ( equation 15 )$$

By squaring the reflection coefficient R (i.e., squaring the above equation 14 or 15) and organizing the values, the following equation 16 is obtained.

$$\begin{matrix}{\vert R \vert}^{2} = \frac{{B}^{2} + {( {ε}_{r} - 1 )}^{2}}{{B}^{2} + {( {ε}_{r} + 1 )}^{2}} \\ = 1 + \frac{{B}^{2} + {( {ε}_{r} - 1 )}^{2} - {B}^{2} - {( {ε}_{r} + 1 )}^{2}}{{B}^{2} + {( {ε}_{r} + 1 )}^{2}} \\ = 1 - \frac{{ε}_{r}^{2} + 2 {ε}_{r} + 1 - {ε}_{r}^{2} + 2 {ε}_{r} - 1}{{B}^{2} + {( {ε}_{r} + 1 )}^{2}} \\ = 1 - \frac{4 {ε}_{r}}{{B}^{2} + {( {ε}_{r} + 1 )}^{2}}\end{matrix} \qquad ( equation 16 )$$

The above equation 16 indicates that when B is equal to 0, the denominator becomes the minimum and |R|² has the maximum value. By substituting 0 into B in the above equation 16 and organizing the values, the following equation 17 is obtained to find the maximum reflection coefficient.

$${\vert R \vert}^{2} = 1 - \frac{4 {ε}_{r}}{{B}^{2} + {( {ε}_{r} + 1 )}^{2}} = \frac{{( {ε}_{r} - 1 )}^{2}}{{( {ε}_{r} + 1 )}^{2}} \qquad ( equation 17 )$$

From the above equation 17, the maximum reflection amount [dB] of the dielectric having the relative permittivity εr is obtained using the following equation 18.

$$20 log \frac{( {ε}_{r} - 1 )}{( {ε}_{r} + 1 )} [ dB ] \qquad ( equation 18 )$$

The operation of the front grille 12 will now be described.

As shown in FIGS. 1 and 4, when millimeter waves are transmitted from the millimeter wave radar device 13, some of the millimeter waves pass through the millimeter wave passage portion 14 of the front grille 12. After passing through the millimeter wave passage portion 14, the millimeter waves (passing waves) strike and are reflected by an object outside the vehicle including, for example, a vehicle leading the vehicle 11 and pedestrians. Then, the millimeter waves again pass through the millimeter wave passage portion 14 of the front grille 12 and are received by the millimeter wave radar device 13. Using the transmitted and received millimeter waves, the millimeter wave radar device 13 recognizes an object and detects, for example, the distance between the vehicle 11 and the object.

Some of the millimeter waves (incident waves) that have been transmitted from the millimeter wave radar device 13 and have entered the millimeter wave passage portion 14 are reflected on the interface of the millimeter wave passage portion 14. For the millimeter wave passage portion 14, the front and rear surfaces of the millimeter wave passage portion 14 correspond to an interface facing the air.

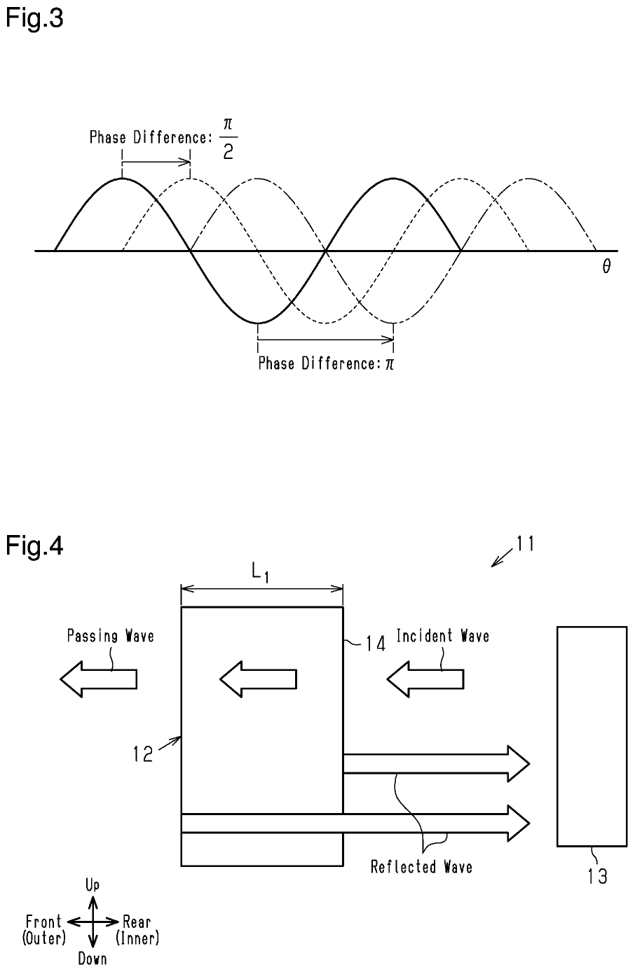

Some of the incident waves are reflected rearward on the front and rear surfaces of the millimeter wave passage portion 14. As shown in FIGS. 2 and 3, phase deviation (phase difference) occurs between the millimeter waves (reflected waves) reflected on the front surface of the millimeter wave passage portion 14 and the millimeter waves (reflected waves) reflected on the rear surface of the millimeter wave passage portion 14.

In this case, thickness L₁ of the millimeter wave passage portion 14 satisfies the above equation 2. Thus, in the millimeter wave passage portion 14, the phase between each reflected wave on the front surface and the corresponding reflected wave on the rear surface is deviated by π, and these waves are in antiphase. Accordingly, the reflected wave reflected on the front surface of the millimeter wave passage portion 14 (shown by the solid line in FIG. 3) and the reflected wave reflected on the rear surface of the millimeter wave passage portion 14 (shown by the long dashed double-short dashed line in FIG. 3) offset each other. In other words, the phases are cancelled. This effectively limits the reflection of millimeter waves on the millimeter wave passage portion 14 and thus improves the accuracy in detecting the object by the millimeter wave radar device 13.

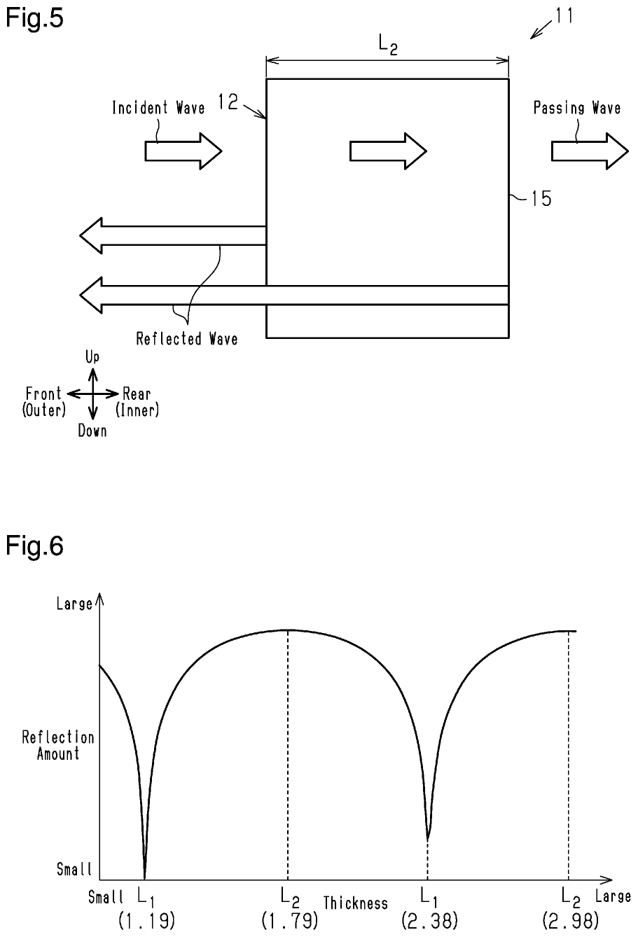

Referring to FIGS. 1 and 5, when millimeter waves are transmitted from a millimeter wave radar device (not shown) of a different vehicle, some of the millimeter waves strike the millimeter wave reflection portion 15 of the front grille 12 of the vehicle 11. The millimeter waves that have struck and have been reflected by the millimeter wave reflection portion 15 are again received by the millimeter wave radar device of the different vehicle. Using the transmitted and received millimeter waves, the millimeter wave radar device of the different vehicle recognizes the vehicle 11 and detects, for example, the distance between the different vehicle and the vehicle 11.

Some of the millimeter waves (incident waves) that have been transmitted from the millimeter wave radar device of the different vehicle and have entered the millimeter wave reflection portion 15 of the front grille 12 are reflected on the interface of the millimeter wave reflection portion 15. For the millimeter wave reflection portion 15, the front and rear surfaces of the millimeter wave reflection portion 15 correspond to an interface facing the air.

Some of the incident waves are reflected frontward on the front and rear surfaces of the millimeter wave reflection portion 15. Phase deviation (phase difference) does not occur between the millimeter waves (reflected waves) reflected on the front surface of the millimeter wave reflection portion 15 and the millimeter waves (reflected waves) reflected on the rear surface of the millimeter wave reflection portion 15.

In this case, thickness L₂ of the millimeter wave reflection portion 15 satisfies the above equation 1. Thus, in the millimeter wave reflection portion 15, each reflected wave on the front surface and the corresponding reflected wave on the rear surface are in phase. Accordingly, the reflected waves reflected on the front surface of the millimeter wave reflection portion 15 and the reflected waves reflected on the rear surface of the millimeter wave reflection portion 15 intensify each other. This allows the millimeter waves from the different vehicle to be effectively reflected on the millimeter wave reflection portion 15, and thus improves the accuracy of the millimeter wave radar device of the different vehicle detecting the vehicle 11.

An example of the front grille 12 that satisfies the above equations 1 and 2 will now be described.

In this example, the entire front grille 12 is made of polycarbonate that serves as a dielectric. The frequency of the millimeter wave is 76.5 GHz. Wavelength λ of this millimeter wave in the air is calculated to 3.92 mm by dividing the speed (3.0×10⁸ m/s) of the millimeter wave by the frequency (76.5×10⁹ Hz) of the millimeter wave.

The relative permittivity εᵣ of polycarbonate is 2.703, and n is an integer greater than or equal to 0. Wavelength λg of the millimeter wave in the polycarbonate is calculated to 2.38 mm by dividing wavelength λ (3.92 mm) of the millimeter wave in the air by the square root of the relative permittivity εᵣ (2.703) of the polycarbonate.

When 2.38 is substituted into λg in the above equation 2, thickness L₁ of the millimeter wave passage portion 14 is 1.19 mm, 2.38 mm, . . . as shown in the graph of FIG. 6. That is, the millimeter wave passage portion 14 is in an anti-reflective state in which the reflection coefficient R is 0 when thickness L₁ is the half of the wavelength of a millimeter wave in the millimeter wave passage portion 14.

In contrast, when 2.38 is substituted into λg in the above equation 1, thickness L₂ of the millimeter wave reflection portion 15 is 0.596 mm, 1.79 mm, 2.98 mm, . . . as shown in the graph of FIG. 6. That is, the millimeter wave reflection portion 15 is in a maximum reflection state in which the reflection coefficient R is the maximum when thickness L₂ is an odd multiple of one-fourth of the wavelength of a millimeter wave in the millimeter wave reflection portion 15.

The calculation of an optimal thickness that allows millimeter waves to pass through when the front grille 12 is formed by laminating a double-layer dielectric will now be described.

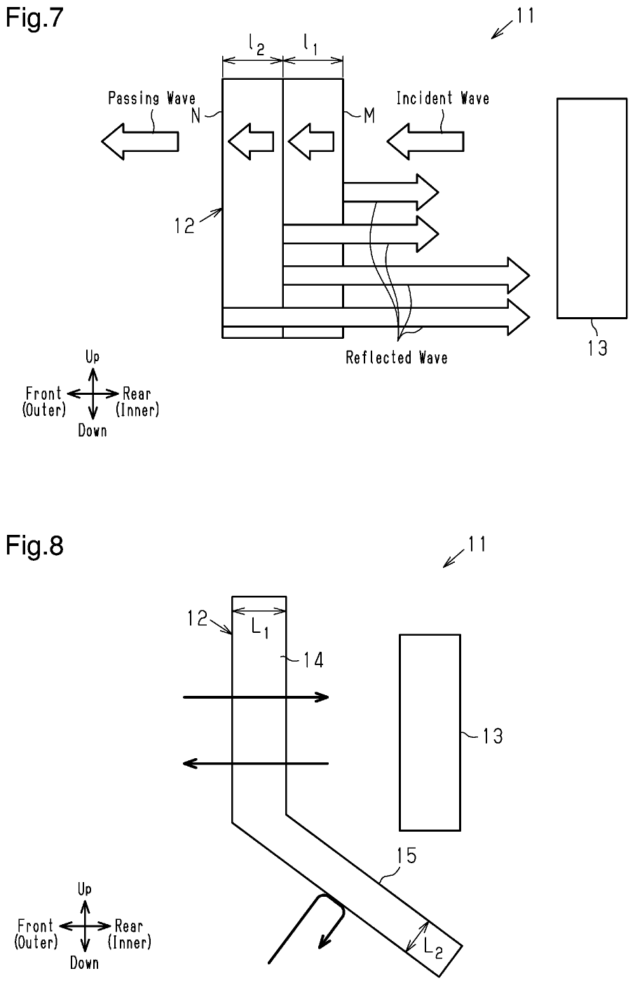

As shown in FIG. 7, the front grille 12 is formed by laminating a first dielectric M and a second dielectric N. The relative permittivity of the first dielectric M is ε_{α}. The relative permittivity of the second dielectric N is ε_{β}. Reflected waves are reflected on the opposite end faces of the first dielectric M in a transmission direction of millimeter waves (the direction from the right toward the left in FIG. 7). The phases of these reflected waves are deviated by a phase deviation amount α, which is equal to β₁1₁. Reflected waves are reflected on the opposite end faces of the second dielectric N in the transmission direction of millimeter waves. The phases of these reflected waves are deviated by a phase deviation amount β, which is equal to β₂1₂.

1₁ refers to the thickness of the first dielectric M in the transmission direction of millimeter waves. 1₂ refers to the thickness of the second dielectric N in the transmission direction of millimeter waves. β₁ refers to the propagation constant of the first dielectric M. β₂ refers to the propagation constant of the second dielectric N.

F matrices in which the first dielectric M and the second dielectric N are combined are expressed by the following equation 19 by connecting the F matrices indicating the dielectrics in a cascade. Zo represents a characteristic impedance in a vacuum, and j represents an imaginary unit.

$$\begin{matrix}F = [ \begin{matrix}cos α & j \frac{{Z}_{0}}{\sqrt{{ε}_{α}}} sin α \\ j \frac{\sqrt{{ε}_{α}} sin α}{{Z}_{0}} & cos α\end{matrix} ] [ \begin{matrix}cos β & j \frac{{Z}_{0}}{\sqrt{{ε}_{β}}} sin β \\ j \frac{\sqrt{{ε}_{β}} sin β}{{Z}_{0}} & cos β\end{matrix} ] \\ = [ \begin{matrix}cos α cos β - \frac{\sqrt{{ε}_{β}}}{\sqrt{{ε}_{α}}} sin α sin β & {jZ}_{0} ( \frac{1}{\sqrt{{ε}_{β}}} cos α sin β + \frac{1}{\sqrt{{ε}_{α}}} sin α cos β ) \\ j \frac{\sqrt{{ε}_{α}} sin α cos β + \sqrt{{ε}_{β}} cos α sin β}{{Z}_{0}} & - \frac{\sqrt{{ε}_{α}}}{\sqrt{{ε}_{β}}} sin α sin β + cos α cos β\end{matrix} ] \\ = [ \begin{matrix}A & E \\ C & D\end{matrix} ]\end{matrix} \qquad ( equation 19 )$$

From the F matrices in the above equation 19, the reflection coefficient R is calculated using the above equation 4. All of the millimeter waves pass (completely pass) through the front grille 12 on condition that the reflection coefficient R is 0. Thus, the value of the numerator in the above equation 4 simply needs to be 0. Accordingly, by substituting the values of the F matrices of the above equation 19 into the expression of the numerator in equation 4 and organizing these values, the following equation 20 is obtained.

$$A + \frac{E}{{Z}_{0}} - {Z}_{0} C - D = cos α cos β - \frac{\sqrt{{ε}_{β}}}{\sqrt{{ε}_{α}}} sin α sin β + j ( \frac{1}{\sqrt{{ε}_{β}}} cos α sin β + \frac{1}{\sqrt{{ε}_{α}}} sin α cos β ) - j ( \sqrt{{ε}_{α}} sin α cos β + \sqrt{{ε}_{β}} cos α sin β ) + \frac{\sqrt{{ε}_{α}}}{\sqrt{{ε}_{β}}} sin α sin β - cos α cos β = ( \frac{\sqrt{{ε}_{α}}}{\sqrt{{ε}_{β}}} - \frac{\sqrt{{ε}_{β}}}{\sqrt{{ε}_{α}}} ) sin α sin β + j \{ ( \frac{1}{\sqrt{{ε}_{α}}} - \sqrt{{ε}_{α}} ) sin α cos β + ( \frac{1}{\sqrt{{ε}_{β}}} - \sqrt{{ε}_{β}} ) cos α sin β \} \qquad ( equation 20 )$$

The above equation 20 indicates that for the numerator to become 0, the following equations 21 and 22 need to be both satisfied.

$$sin α sin β = 0 \qquad ( equation 21 )$$

$$( \frac{1}{\sqrt{{ε}_{α}}} - \sqrt{{ε}_{α}} ) sin α cos β + ( \frac{1}{\sqrt{{ε}_{β}}} - \sqrt{{ε}_{β}} ) cos α sin β = 0 \qquad ( equation 22 )$$

The above equations 21 and 22 include two variables, namely, α and β. Thus, it is assumed that one of the two variables is 0. By substituting 0 into a in the above equations 21 and 22, sinβ becomes equal to 0 in either equation. By substituting 0 into β in the above equations 21 and 22, sinα becomes equal to 0 in either equation. Accordingly, for the reflection coefficient R to become 0, sinα and sinβ both need to be 0.

Since sinα is equal to 0 and α is equal to β₁1₁, β₁1₁ is equal to nπ (n is an integer). The relationship between the wavelength and propagation constant indicates that β₁ is equal to 2π/λg and λg is equal to λ/√ε_{α}. In this case, λ represents the wavelength of a millimeter wave in the air, and λg represents the wavelength of a millimeter wave in the first dielectric M. Thus, the following equation 23 is obtained to find thickness 1₁ of the first dielectric M, which is optimal for the passage of millimeter waves.

$${l}_{1} = n \frac{λ g}{2} = n \frac{λ}{2 \sqrt{{ε}_{α}}} ( n is an integer greater than or equal to 0 ) \qquad ( equation 23 )$$

Since sinβ is equal to 0 and β is equal to β₂1₂, β₂1₂ is equal to nπ (n is an integer). The relationship between the wavelength and propagation constant indicates that β₂ is equal to 2π/λg and λg is equal to λ/√ε_{β}. In this case, λ represents the wavelength of a millimeter wave in the air, and λg represents the wavelength of a millimeter wave in the second dielectric N. Thus, equation 24 is obtained to find thickness 1₂ of the second dielectric N, which is optimal for the passage of millimeter waves.

$${l}_{2} = n \frac{λ g}{2} = n \frac{λ}{2 \sqrt{{ε}_{β}}} ( n is an integer greater than or equal to 0 ) \qquad ( equation 24 )$$

From the above, the front grille 12 is optimal for the passage of millimeter waves when thickness 1₁ of the first dielectric M and thickness 1₂ of the second dielectric N are combined. That is, the combination of thicknesses 1₁ and 1₂, which are respectively optimal for the passage of millimeter waves in the first dielectric M and the second dielectric N, allows for the passage of millimeter waves through the double-layer front grille 12, in which the first dielectric M and the second dielectric N are laminated.

Likewise, an optimal thickness can be set for the reflection of millimeter waves on the double-layer front grille 12, in which the first dielectric M and the second dielectric N are laminated.

The combination of thicknesses 1₁ and 1₂, which are respectively optimal for the passage of millimeter waves through the first dielectric M and the second dielectric N, would result in the following problem. Depending the constraints on a product such as the front grille 12 or the specification of the product, it is difficult to set the thickness of each of the first dielectric M and the second dielectric N to be optimal for the passage. In such a case, for millimeter waves to pass through the entire product, the average relative permittivity of dielectrics included in the product is calculated.

In one example, the relative permittivity of a product in which four dielectrics are laminated is calculated. In this case, the relative permittivities of the four dielectrics are respectively ε_{A}, ε_{B}, ε_{C}, ε_{D}, the thicknesses of the four dielectrics are respectively t_{A}, t_{B}, t_{C}, t_{D}, and the total thickness of them is tₜₒₜₐₗ. Then, the average relative permittivity of the four dielectrics is obtained using the following equation 25.

$$\frac{( {ε}_{A} * {t}_{A} ) + ( {ε}_{B} * {t}_{B} ) + ( {ε}_{C} * {t}_{c} ) + ( {ε}_{D} * {t}_{D} )}{{t}_{t o t a l}} \qquad ( equation 25 )$$

For example, ε_{A}, ε_{B}, ε_{C}, ε_{D}, are respectively 2.0, 2.7, 2.5, 2.6, and t_{A}, t_{B}, t_{C}, t_{D}, are respectively 0.4 mm, 4.2 mm, 0.1 mm, 1.2 mm. In this case, tₜₒₜₐₗ, which is total of t_{A}, t_{B}, t_{C}, t_{D}, is 5.9 mm. When these values are substituted into the above equation 25, the average relative permittivity is 2.63. Thus, the product including the four dielectrics is interpreted as a product in which the relative permittivity εᵣ is 2.63 and thickness L is 5.9 mm.

As described above, when each millimeter wave has a frequency of 76.5 GHz, wavelength λ of the millimeter wave in the air is 3.92 mm. When 2.63 is substituted into εᵣ and 3.92 is substituted into λ in equation 9, thickness L of the product is 1.21n (n is an integer greater than or equal to 0). That is, the above product allows millimeter waves to pass through to the maximum extent when thickness L is an integral multiple of 1.21 mm. Thus, when thickness L of the product is 5.9 mm, millimeter waves do not allow for optimal passage.

When 2.63 is substituted into εᵣ and 3.92 is substituted into λ in equation 13, thickness L of the product is 1.21n+0.604 (n is an integer greater than or equal to 0). That is, in the above product, when thickness L is an integral multiple of 1.21 mm plus 0.604 mm, the maximum reflection is achieved. Thus, when thickness L of the product is 5.9 mm, the optimal reflection is not achieved.

Accordingly, in order for the product to achieve the optimal passage and reflection with millimeter waves each having a frequency of 76.5 GHz, thickness L and the relative permittivity εᵣ of the product simply need to be adjusted. Further, in order for the product to achieve the optimal passage and reflection when thickness L of the product is 5.9 mm and the relative permittivity εᵣ is 2.63, the frequency of the millimeter wave simply needs to be changed.

The above embodiment described in detail has the following advantages.

(1) In the front grille 12, thickness L₂ of the millimeter wave reflection portion 15 is set based on the above equation 1. This structure allows for the calculation of thickness L₂ of the millimeter wave reflection portion 15, which allows millimeter waves to be reflected to the greatest extent. Thus, by setting thickness L₂ of the millimeter wave reflection portion 15 such that the millimeter wave reflection portion 15 reflects millimeter waves to the greatest extent, the vehicle 11 is easily detected by the millimeter wave radar device incorporated in a different vehicle.

(2) The front grille 12 is arranged in a path of the millimeter waves transmitted and received by the millimeter wave radar device 13. The front grille 12 includes the millimeter wave passage portion 14, through which millimeter waves pass. In this structure, the millimeter waves transmitted and received by the millimeter wave radar device 13 pass through the millimeter wave passage portion 14. This restricts situations in which the millimeter wave radar device 13 is prevented from detecting, for example, an object outside the vehicle.

(3) In the front grille 12, the millimeter wave passage portion 14 and the millimeter wave reflection portion 15 are integrally arranged. That is, the front grille 12 includes the one-piece component, which includes the millimeter wave passage portion 14 and the millimeter wave reflection portion 15. In this structure, as compared with when the millimeter wave passage portion 14 and the millimeter wave reflection portion 15 are separate from each other, fewer components are used. Additionally, since there is no boundary between the millimeter wave passage portion 14 and the millimeter wave reflection portion 15, the design of the front grille 12 is improved.

Modifications

The above embodiment may be modified as follows. The above embodiment and the following modifications can be combined as long as the combined modifications remain technically consistent with each other.

As shown in FIG. 8, the front grille 12 may be substantially V-shaped. More specifically, the millimeter wave passage portion 14 may be located in front of the millimeter wave radar device 13 and the millimeter wave reflection portion 15 may be located on the diagonally lower front side of the millimeter wave radar device 13. This structure allows the millimeter wave reflection portion 15 to limit situations in which, for example, when millimeter waves are transmitted from the millimeter wave radar device 13 of the vehicle 11 during traveling so as to strike and be reflected on the ground, the millimeter waves are detected by the millimeter wave radar device 13. That is, this structure limits situations in which the millimeter wave radar device 13 erroneously detects, for example, a protrusion on the ground as a different vehicle or the like.

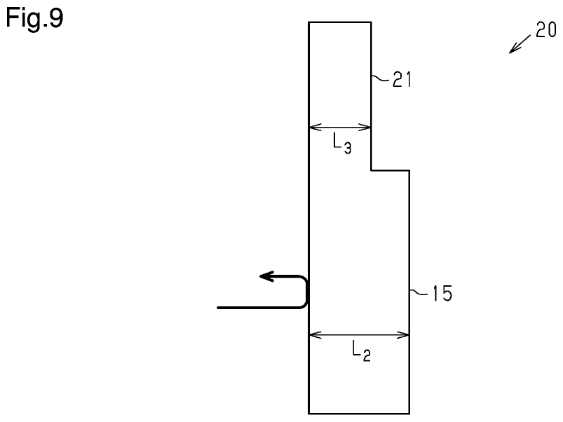

As shown in FIG. 9, the vehicle component may be, for example, a rear bumper 20. The rear bumper 20 is located outside a path of millimeter waves for the millimeter wave radar device 13. The rear bumper 20 may be made of, for example, the same material as the front grille 12. The rear bumper 20 includes the millimeter wave reflection portion 15 and a general portion 21. The general portion 21 has thickness L₃ that does not easily reflect millimeter waves or permit millimeter waves to easily pass through. Since the rear bumper 20 is located outside the path of millimeter waves for the millimeter wave radar device 13, the rear bumper 20 does not need to include the millimeter wave passage portion 14, which permits the passage of millimeter waves from the millimeter wave radar device 13. Accordingly, the rear bumper 20 simply needs to include at least the millimeter wave reflection portion 15, which reflects millimeter waves from the millimeter wave radar device of a different vehicle.

This structure allows the millimeter wave reflection portion 15 of the rear bumper 20 to effectively reflect millimeter waves from the millimeter wave radar device of the different vehicle. Thus, the vehicle 11 is easily detected by the millimeter wave radar device incorporated in the different vehicle. The vehicle component located outside a path of millimeter waves for the millimeter wave radar device 13 does not have to be the rear bumper 20 and may be a back door garnish, a fender panel arranged at a side portion of the vehicle 11, or the like. The vehicle component located outside the path of millimeter waves for the millimeter wave radar device 13 may be all included in the millimeter wave reflection portion 15.

In the front grille 12, the millimeter wave passage portion 14 and the millimeter wave reflection portion 15 do not have to be integrally arranged. That is, the millimeter wave passage portion 14 and the millimeter wave reflection portion 15 may be separate from each other.

The front grille 12 may be formed by laminating two or more dielectrics.

The vehicle component is applicable as long as the vehicle component is incorporated in a vehicle equipped with a radar device that transmits and receives electromagnetic waves used to detect an object outside the vehicle. In this case, examples of the electromagnetic waves transmitted and received by the radar device include electromagnetic waves such as infrared rays, in addition to millimeter waves.

The radar device that transmits and receives electromagnetic waves used to detect an object outside the vehicle does not have to be a front-monitoring radar device. Instead, this radar device may be a rear-monitoring radar device, a side-monitoring radar device for the front part, or a side-monitoring radar device for the rear part. In this case, the vehicle component is arranged in front of the radar device in the direction in which electromagnetic waves are transmitted.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle component comprising an electromagnetic wave reflection portion that reflects an electromagnetic wave, the vehicle component being made of a dielectric, wherein
thickness L₂ of the electromagnetic wave reflection portion is set based on the following equation 1:
$${L}_{2} = ( 2 n + 1 ) \frac{λ g}{4} \qquad ( equation 1 )$$
where n is an integer greater than or equal to 0 and λg is a wavelength of the electromagnetic wave in the dielectric.

2. The vehicle component according to claim 1, wherein
the vehicle component is arranged in a path of an electromagnetic wave for a radar device that transmits and receives the electromagnetic wave, and
the vehicle component further comprises an electromagnetic wave passage portion through which the electromagnetic wave for the radar device passes.

3. The vehicle component according to claim 2, comprising a one-piece component that includes the electromagnetic wave passage portion and the electromagnetic wave reflection portion.
